(19) United States
(12) Patent Application Publication
(10) Pub. No.: US 2024/0238786 A1
(43) Pub. Date: Jul. 18, 2024

(54) DROPLET SORTATION

(71) Applicant: Verily Life Sciences LLC, South San Francisco, CA (US)

(72) Inventors: Saurabh Vyawahare, Mountain View, CA (US); Andrew Homyk, Belmont, CA (US)

(21) Appl. No.: 18/563,200

(22) PCT Filed: May 20, 2022
(86) PCT No.: PCT/US2022/072469

§ 371 Date: Nov. 21, 2023

Related U.S. Application Data
(60) Provisional application No. 63/196,368, filed on Jun. 3, 2021.

(51) Int. Cl. B01L 3/00

(52) U.S. Cl. CPC B01L 3/502761; B01L 2200/0652; B01L 2300/023; B01L 2300/0864; B01L 2300/0883; B01L 2400/0415

(57) ABSTRACT

A droplet sorting device is described. The droplet sorting device includes a primary channel, a sorting channel, a sorting electrode, a ground film, and an insulating layer. The sorting channel may intersect the primary channel to define a sorting junction. The sorting electrode may be disposed in a first plane adjacent to the sorting junction. The ground film may be disposed in a second plane that is different from the first plane. The insulating layer may be disposed in a third plane that is located between the first and second planes.

### BACKGROUND

Uniformly sized droplets, made with microfluidics, are extensively used in single cell analysis and droplet polymer chain reactions. Cell-based sorting may include combining cells with droplets, detecting features of the cells within the droplets, and using a sorting device to singulate and sort the droplets based on the detected features.

### BRIEF SUMMARY

Various examples are described relating to droplet sorting devices, systems including droplet sorting devices, and methods of using and forming droplet sorting devices.

One general aspect includes a sorting device. The sorting device includes a primary channel extending between a primary inlet and a primary outlet. The sorting device also includes a sorting channel extending between a sorting inlet and a sorting outlet, where the sorting inlet intersects the primary channel between the primary inlet and the primary outlet at a sorting junction. The sorting device also includes a sorting electrode including a distal portion located adjacent the sorting junction, where the primary channel, the sorting channel, and the sorting electrode are disposed in a first plane. The sorting device also includes a ground film disposed in a second plane that is distinct from the first plane. The sorting device also includes an insulating layer disposed in a third plane that is located between the first plane and the second plane.

One general aspect includes a different sorting device. The sorting device includes a first substrate. The sorting device also includes a second substrate defining a first plurality of electrode channels and a second plurality of fluidic channels. The sorting device also includes a conductive material layer disposed between the first substrate and the second substrate, where the first plurality of electrode channels overlay a portion of the conductive material layer and are configured to form a plurality of independent electrical connections between the first plurality of electrode channels and the conductive material layer. The sorting device also includes an insulating layer disposed between the first substrate and the conductive material layer.

One general aspect includes a different sorting device. The sorting device includes a primary channel extending between a primary inlet and a primary outlet. The sorting device also includes a plurality of sorting junctions defined adjacent to the primary channel between the primary inlet and the primary outlet, where each sorting junction of the plurality of sorting junctions includes: a sorting channel extending between a sorting inlet that intersects the primary channel at a respective sorting junction and a sorting outlet, and a sorting electrode with a distal portion located adjacent to the respective sorting junction. The sorting device also includes a common electrode that is shared with at least two sorting electrodes of the plurality of sorting junctions, where, in operation, the at least two sorting electrodes are independently controllable.

Another general aspect includes a computer-implemented method. The computer-implemented method includes receiving a first signal from an optical system, the first signal representing one or more detected properties of a droplet present in a liquid. The computer-implemented method also includes identifying a sorting junction of a plurality of sorting junctions of a sorting device based on the one or more detected properties, the sorting junction including an intersection between a primary channel and a sorting channel. The computer-implemented method also includes prior to the droplet arriving at the sorting junction, causing a voltage to be applied to a sorting electrode disposed in a first plane of the sorting device and associated with the sorting junction, the voltage causing electric charges to flow from the sorting electrode to a ground film disposed in a second plane of the sorting device that is distinct from the first plane, the electric charges creating an electrical field at the sorting junction that directs the droplet from the primary channel to the sorting channel. Other embodiments of this aspect include corresponding computer systems, apparatus, and computer programs recorded on one or more computer storage devices, each configured to perform the actions of the methods.

Another general aspect includes a method of forming a sorting device. The method includes forming a primary channel in a first plane. The method also includes forming, in the first plane, a set of sorting channels that intersect the primary channel at a plurality of intersections. The method also includes forming a set of sorting electrodes in the first plane. The method also includes forming a ground film in a second plane that is distinct from the first plane.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates a diagram of an example droplet sorting system, according to at least one example.

FIG. 2 illustrates a cross-sectional view of a droplet sorting device, according to at least one example.

FIG. 3 illustrates a top view of a droplet sorting device, according to at least one example.

FIG. 4 illustrates a detailed view of a sorting junction, according to at least one example.

FIG. 5 illustrates a perspective view sectional view of a droplet sorting system, according to at least one example.

FIG. 6A illustrates a cross-sectional view of a droplet sorting device, according to at least one example.

FIG. 6B illustrates top and bottom views of the droplet sorting device of FIG. 6A, according to at least one example.

FIG. 6C illustrates a detailed view of a portion of the droplet sorting device of FIG. 6A, according to at least one example.

FIG. 7 illustrates an example flow chart depicting a process for sorting droplets according to at least one example.

FIG. 8 illustrates a computer system corresponding to a droplet sorting system, according to at least one example.

### DETAILED DESCRIPTION

Examples are described herein in the context of droplet sorting devices such as those for sorting immune cells. Those of ordinary skill in the art will realize that the following description is illustrative only and is not intended to be in any way limiting. For example, the features described with respect to immune cell sorting are applicable to any sorting of any other small object suspended in a fluid. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Microfluidic sorting includes the process of creating aqueous droplets that include an object to be sorted, gathering information about the droplets and/or its contents (e.g., identifying features), conveying the droplets in a carrier fluid to a set of sorting junctions arranged in a series, and, depending on the features of each droplet, causing the droplet to be conveyed out of a main channel at one sorting junction of the set of sorting junctions. At a sorting junction, dielectrophoresis may be used to direct a droplet out of the main channel. The droplets have a higher dielectric constant compared to the surrounding carrier fluid, and an electric field gradient, applied at the right time, can pull a droplet out of the main channel and into a sorting channel adjacent the sorting junction. In conventional microfluid sorting devices, pairs of rigid electrodes are positioned near the sorting junctions in the same plane and as the main channel and sorting channels. Such a planar geometry may mean that the electrodes also have heights that are similar to the main channel and sorting channel. This planar arrangement of electrodes and channels makes creating many sorting junctions in a small area quite difficult because of geometric limitations (e.g., the area that must be devoted to a pair of electrodes per sorting junction is higher than the described device). Additionally, such an arrangement may also result in suboptimal electric field gradients (e.g., gradients that cannot move droplets in an efficient manner, gradients that break droplets, and otherwise result in suboptimal movement of the droplets).

Examples described herein are directed to microfluidic droplet sorting systems, droplet sorting devices, and techniques for manufacturing and using such systems and devices. The described droplet sorting devices address the problems with conventional sorting devices by using a ground film disposed below sorting junctions and an electrode in the same plane as fluidic channels at the sorting junction. Use of a flowable liquid electrode may also increase sorting junction density. In an example, the droplet sorting device may include a main channel by which a carrier fluid (and droplets) can flow and a plurality of intersecting side channels (for providing additional carrier fluid) and a plurality of intersecting sorting outlets (for carrying away droplets that have been sorted). A sorting junction is defined at each intersection of a side channel and a sorting outlet. The droplet sorting devices include a structural design that enables construction of tens of sorting junctions in a small area, sorting at high droplet rates as compared to conventional devices, and can be constructed using plastic injection molding. Part of such design includes the configuration of an electrode system at each sorting junction. In particular, the electrode system may include, at each sorting junction, a common ground film that is formed in a layer below a layer in which the channels (e.g., main, side, and side outlet) are formed. The electrode system may also include, at each sorting junction, an active electrode that is selectively operable, is formed in the same layer as the fluidic channels, and has a geometry that corresponds to the geometry of the channels. For example, the active electrode may be considered a three-dimensional electrode as compared to the ground film, and may therefore have a height that is about equal with the height of the channels, or at least the main channel. The ground film may be common with respect to multiple active electrodes disposed at multiple different sorting junctions. In operation, the configuration of the ground film below the sorting junction and the active electrode having a taller geometry results in lower voltages needed for sorting as compared to two-electrode configurations (e.g., two electrodes in the same plane as the channels), and, because of the increased density of sorting junctions, the system throughput may be improved. Such geometry may also enable more uniform forces on the droplets, which reduces the likelihood of deformation, splitting, and/or squishing of droplets, as compared to conventional planar geometries.

Turning now to a first particular example, in this example, there is provided a droplet sorting device. The droplet sorting device may be formed from multiple layers. A lower layer may include a glass substrate on which is formed a conductive film such as a thin layer of gold. An insulating layer may be arranged such that the conductive film is between the insulating layer and the substrate. The conductive film may define a common ground layer. In a next layer on top of the insulating layer may be formed fluidic channels and active electrodes. For example, the next layer may be a plastic substrate having a uniform thickness and being generally planar, except for the presence of channels and electrodes formed (or otherwise constructed) within the next layer. For example, a main channel that includes an inlet and an outlet may be formed in the plastic substrate. The main channel may be configured to receive droplets including objects and a carrier fluid. Generally, the carrier fluid may carry the droplets towards the outlet. Multiple sorting channels that intersect the main channel between the inlet and the outlet of the main channel may be formed in the plastic substrate. The sorting channels are configured to convey carrier liquid including diverted droplets towards outlets that can be connected to holders for collection of the objects in the droplets. Multiple side channels that intersect the main channel between the inlet and the outlet of the main channel may also be formed in the plastic substrate. The side channels are configured to introduce additional carrier liquid into the sorting device to make up for carrier fluid that exits via the sorting channels towards the holders. A sorting junction is defined at each intersection of a sorting channel and the main channel. Within each sorting junction is formed an active electrode that is disposed within plastic substrate adjacent to the intersection. The active electrodes may be individually addressable and may share the common ground layer. Because the active electrodes are formed in the same layer as the channels, these electrodes may be about as tall as the channels (e.g., e.g., 30 to 60 microns). The common ground layer, on the other hand, may be formed from one or more layers and may be relatively thin (e.g., between 10 nm and 500 nm). When an electrical voltage is applied to an active electrode, electricity will flow between the active electrode and the ground layer, which causes droplets to be diverted from the main channel and into the corresponding sorting channel towards the corresponding holder.

In a second particular example, there is provided a droplet sorting system that includes a droplet sorting device, an optical apparatus, a mechanical apparatus for retaining sorting devices and holders for collection, and an electronic apparatus including sorting circuits and signal processing circuits. In operation, droplets including objects are formed and viewed by the optical apparatus. A signal is generated by the optical apparatus and sent to the electronic apparatus. The signal may depend on features of a first object detected by the optical apparatus. The signal is processed by the electronic apparatus and used to determine which sorting junction in the sorting device should be used to divert the object to a holder for collection. Once the sorting junction is identified, the electronic apparatus generates and sends an electrical signal to an active electrode at the selected sorting junction. This action creates an electrical field between the active electrode and a ground film of the sorting device that directs the object (in a droplet) towards the selected holder.

The illustrative examples are given to introduce the reader to the general subject matter discussed herein and the disclosure is not limited to these examples. The following sections describe various additional non-limiting examples of droplet sorting devices and corresponding systems.

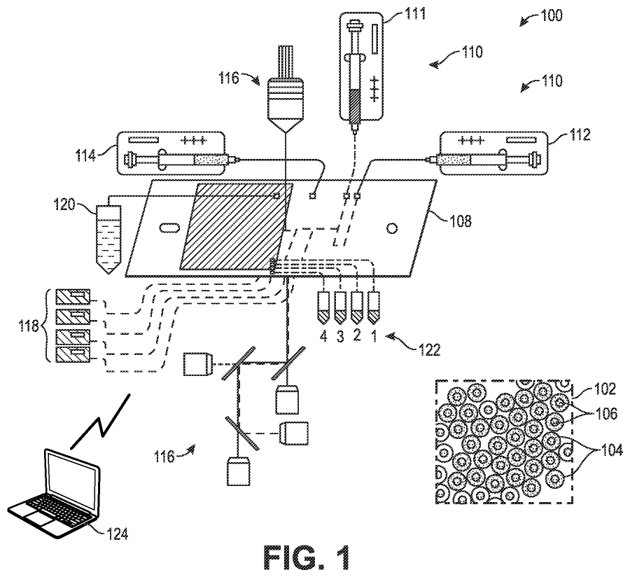

Referring now to the figures, FIG. 1 illustrates a diagram of an example droplet sorting system 100, according to at least one example. The droplet sorting system 100 may be configured to generate droplets 104 and sort the droplets 104 based on one or more features of objects 106 (e.g., size, color, and other features) suspended in the droplets 104. View 102 depicts an enhanced view of a set of sorted droplets 104 that have been sorted using the droplet sorting system 100. In some examples, the objects 106 may be referred to as sorting objects. Examples of objects 106 that may be sorted include cells, molecules, and other small objects.

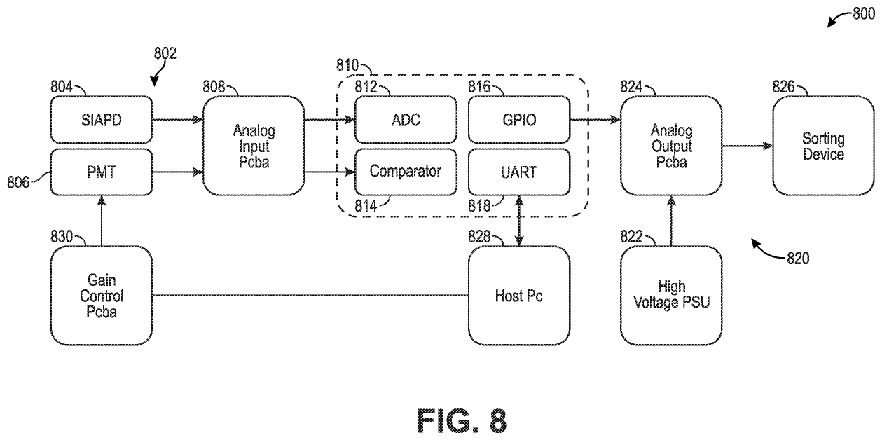

The droplet sorting system 100 includes a droplet sorting device 108, a droplet generation system 110 including a sample supply 111 and a carrier fluid supply 112, side fluid supply 114, a feature detection system 116, an electrode power system 118 configured to selectively and individually power a plurality of active electrodes disposed in the droplet sorting device 108, a waste reservoir 120, a set of sort outputs 122, and a computer system 124 (e.g., computer system 800 of FIG. 8). The computer system 124 may be configured to manage the operation of the elements of the droplet sorting system 100. In some examples, the droplet sorting system 100, including the droplet sorting device 108, may be particularly tuned to sort immune cells, e.g., for single cell sequencing. Such sequencing may include identifying a feature of the cell, sorting based on the feature, collecting similar cells, and performing post processing on the cells. In some examples, the droplet sorting system 100 is compatible with currently used droplet-based single cell sequencing and droplet digital PCR applications. Oil-water droplet systems, while lower in throughput than air-water systems, have an advantage when biochemical processes need to be isolated from each other, for example in antibody generation, enzymatic screening, cell lysis, cell-cell, or cell-bead interactions.

Generally, besides cell sorting, the droplet sorting system 100 can be alternatively configured for high throughput screening (e.g., for antibodies, enzymes, molecules, or cells) instead, where one or more sorting junctions is used in conjunction with moving well plates to deposit individual drops into a well for further processing. This is possible due to the predictability of droplet flow through narrow bore tubing after sorting. In this case, costs can also be reduced with simpler detection systems, as finely resolved, high dimensional fluorescence data is may not be needed for most screening, and image processing in conjunction with a simpler single channel fluorescence detection is suitable. As described herein, COC plastic may be replaceable with other thermoplastics, if high optical transparency or autofluorescence is not a concern.

Generally, the droplet sorting device 108 may be formed according to the description herein. For example, the droplet sorting device 108 may support or otherwise include a ground film, the plurality of active electrodes, and multiple channels connectable to the droplet generation system 110, the side fluid supply 114, the waste reservoir 120, and the set of sort outputs 122. In some examples, the droplet sorting device 108 may be formed as an individual component that may be integrated into the droplet sorting system 100 via various connection points, both electrical and fluidic.

The droplet generation system 110 includes the sample supply 111 and the carrier fluid supply 112, and may be configured to generate droplets. The droplet generation system 110 may also include a nozzle that combines the carrier fluid supply 112 (e.g., an inert fluorinated oil stream) and an aqueous stream (e.g., sample supply 111) to produce droplets. The droplet generation system 110 may include three inlets: two for carrier fluid supply 112, and one for sample supply 111. An example of the carrier fluid may include oil such as HFE-7500. The aqueous fluid of sample supply 111 may be distilled water, a buffer solution, or other similar fluid. The flow rates for producing droplets may be selected to keep flow in the dripping regime, producing uniform size droplets (typically 2-4 μl min−1 for aqueous, and 40-60 μl min−1 for main oil, using syringe pumps). Droplet production rates may range from a few hundred to 4 kHz. The product rate may be selected to avoid droplet shearing and ensure uniform droplet size. In some examples, droplet diameter may vary from 40 to 70 microns, depending on the nozzle geometry and flow rates.

The side fluid supply 114 may be configured to supply additional fluid such as oil to the droplet sorting device 108. The side fluid supply 114 may be configured to supply extra oil to compensate for the loss of oil to the sorting channels. For example, each sorting channel of the droplet sorting device 108 may be configured to divert about between 20% and 50% of the main flow. Without this addition, the droplets may get too close to each other in the main channel and/or the side channels, eventually colliding with each other, making it difficult to predict the timing parameters needed to sort into the downstream sort junctions via the side channels.

The feature detection system 116 may be configured in a detecting region of the droplet sorting device 108, and may be selected depending on the object features being used for sorting. In some examples, the feature detection system 116 may be an optical detection system. The optical detection system may be suitable for detection of fluorescence present in certain cells and/or added to certain cells for detection. The optical detection system may include a set of lasers, cameras, and fluorescence/scattered light detectors that provide information on what cell type is flowing through, along with information on the droplet position and velocity. For example, in a particular configuration, the system may include four lasers (e.g., outputting laser light having wavelengths of 405 nm, 488 nm, 532 nm, and 647 nm, respectively, or any other suitable wavelengths), two cameras imaging from above and below the droplet sorting device 108, and multiple optical detectors (e.g., photomultiplier tubes or photodiodes). Each of optical detectors may be placed behind a chain of optical filters. As the droplets flow through the droplet sorting device 108, the set of lasers may probe the droplets.

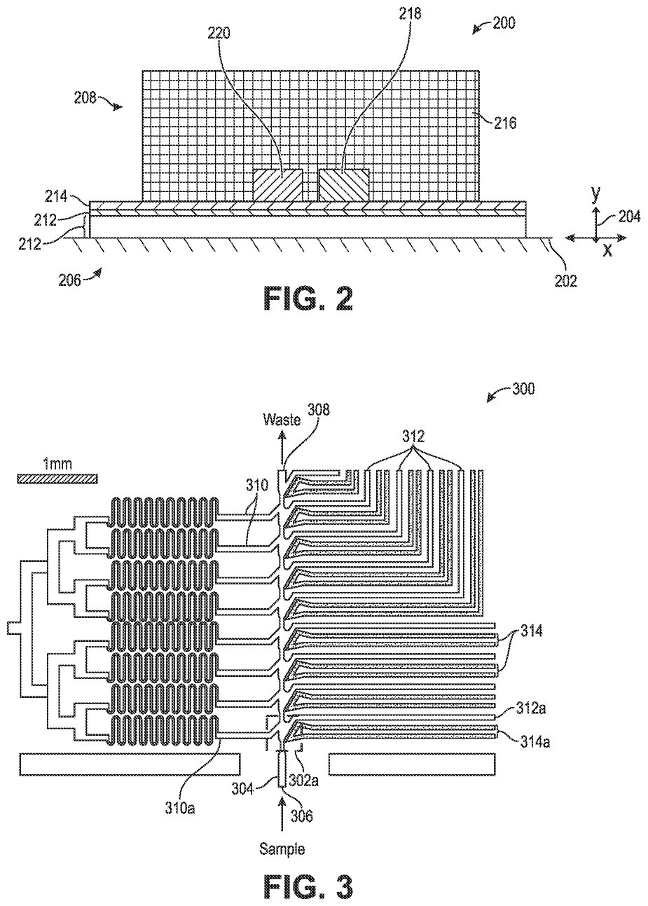

The drops flow into a narrowing region where they can be probed by lasers. The overall optical schematic is shown in FIGS. 2 and 3. The optical detection system consists of a set of lasers, cameras, and fluorescence/scattered light detectors that provide information on what cell type is flowing through, along with information on the droplet position and velocity. The feature detection system 116 may be configured to generate signals about detected features of the objects. These signals can be sent to the computer system 124 for further processing (e.g., to convert into instructions for controlling the operation of sorting junctions by providing electrical voltage to an active electrode of the electrode power system 118).

After the detection region, the droplets flow into the sorting region of the droplet sorting device 108, which may include many sorting junctions. Each sorting junction contains an active electrode, a sort output, and an additional oil input that comes from the side fluid supply 114. As introduced herein, the electrode power system 118 may be configured to selectively power individual active electrodes of the plurality of electrodes at the sorting junctions. Unlike conventional sorting devices that include two active electrodes disposed in the same plane, the droplet sorting device 108 may include, at each sorting junction, a single active electrode and a ground conductor in a different plane below the single active electrode. Activation of one of the active electrodes by the electrode power system 118 may cause a voltage spike at the active electrode, which will then transfer to the ground conductor. This action may be sufficient to divert a droplet from the main channel to a sorting channel and ultimately into one of the sort outputs 122. In some examples, the electrode power system 118 may apply a high electrical voltage AC pulse (e.g., ±500-800 V, 10-15 kHz, 1 ms long) to the specific electrode, just as a droplet enters the sorting junction. This application of the electrical voltage at the specific electrode causes electric charges to flow via the insulating layer between the specific electrode and the ground conductor. The sort outputs 122 may correspond to each sorting junction. In other words, a first sorting junction may be configured to divert objects into a first sort output 122, a second sorting junction may be configured to divert objects into a second sort output 122, and so on and so forth for all sort junctions. Thus, the ratio of sorting junction to sort outputs may be 1:1. In some examples, the ratio may be 1 to many or many to 1. Fluid that is not diverted to one of the sort outputs 122 is captured in the waste reservoir 120.

FIG. 2 illustrates a cross-sectional view of a droplet sorting device 200, according to at least one example. The droplet sorting device 200, sometimes referred to herein as a sorting chip, is an example of the droplet sorting device 108. The droplet sorting device 200 of FIG. 2, which is not drawn to scale, may particularly illustrate the different layers that make up the droplet sorting device 200. Portions of the droplet sorting device 200 may be formed from elastomeric polydimethylsiloxane (PDMS) or other suitable material. In some examples, PDMS may be suitable for quickly and efficiently building prototype droplet sorting devices 200 and, in some examples, may be suitable for larger scale manufacturing. In some examples, as described elsewhere herein, portions of the droplet sorting device 200 may be formed using injection molding techniques.

The droplet sorting device 200 is illustrated as resting on a surface 202 and oriented in a manner extending in a positive Y direction, as shown by axes 204. The droplet sorting device 200 may include a lower portion 206 and an upper portion 208. The lower portion 206 may be formed separate from the upper portion 208, which may then be joined together with the upper portion 208 as part of a later processing step. The lower portion 206 includes substrate 210 as a bottommost layer, a ground film 212 as a next layer, and an insulator 214 formed as a next layer, such that the ground film 212 is disposed between the substrate 210 and the insulator 214. The layers of the lower portion 206 may be generally planar. The substrate 210 may be formed from glass. For example, the substrate 210 may be a glass slide. The ground film 212, which may be gold, indium tin oxide, or other suitable conductive material may be applied to the substrate 210. In some examples, only a portion of the substrate 210 is covered by the ground film 212 (e.g., half or less of the substrate 210). The insulator 214 may be formed from any suitable insulating material such as a layer of glass or PDMS. The thickness of the substrate 210 may be about 20 to 50 microns. The thickness of the ground film 212 may be about 10 nm and 500 nm (e.g., a layer of chromium at about 5 nm, a layer of gold at about 20 nm, and a layer of glass at about 20 nm). The thickness of the insulator 214 may be about 20 to 50 microns. While the ground film 212 is referred to as “film,” it should be understood that such description relates to its thickness as compared to the electrode 220, rather than its manufactured property. For example, the ground film 212 may be applied to the substrate in a film form (e.g., from a roll), deposited from a liquid, and/or applied in any other manner suitable for application of the described materials at the described thicknesses.

The upper portion 208 may be formed from PDMS or other suitable material. The upper portion 208 may include a bulk substrate 216 in which is formed a fluidic channel 218 and an electrode 220 disposed within an electrode channel. For example, the fluidic channel 218 and electrode channel may be machined or otherwise formed. The fluidic channel 218 which is an example of a main channel, side channel, and/or sorting channel may be configured to convey fluid. The electrode 220, which is an example of an active electrode, may be formed within the electrode channel. For example, the electrode 220 may be an ionic liquid (1-ethyl-3-methylimidazolium tetrafluoroborate), a type of liquid salt. Ionic liquids may have benefits over other flowable and non-flowable conductive materials. For example, ionic liquids do not evaporate, and these electrodes can be used for an extended period of time. Liquid flow makes it relatively easy to fill and remove these electrodes 220, and gives them self-healing properties. The described design for the electrode 220 will work with low-melt solder, silver paste, gallium, or salt water without much change.

In some examples, the dimensions of the fluidic channels 218, e.g., a sorting or main channel, may be selected depending on the size of the droplets and corresponding objects to be sorted. For example, when sorting certain cells, the droplets may be about 30-60 microns in size, and the width (in the X direction) of the fluidic channel 218 may be about 100 microns. The height of the fluidic channel 218 may be about 30-60 microns. The dimensions of the electrode 220 may be similar to those of the fluidic channel 218. In some examples, the heights of the fluidic channel 218 and the electrode 220 may be selected to be nearly the same. The height of the electrode 220 may be much larger (e.g., 2×, 5×, 10×, etc.) that of the ground film 212. The electrode 220 may be separated from the sort channel by about 30-50 micron.

At least one benefit of having the electrode 220 about as tall as the fluidic channel 218 and the ground film 212 located in a layer below the fluidic channel 218 is that the electrical field lines that go into the fluidic channel 218 are well suited for pulling droplets into side channels at sorting junctions. Use of a liquid-metallic electrode material for the electrode 220 may simplify the connections required and may allow for compact designs, especially if many sort junctions are needed. Due to the ground film 212, the forces are directed in the plane of the sorting device 200—sideways towards the electrode 220. This allows the use of a much lower voltage (e.g., reduction of over 100 V), compared to a conventional two-electrode configuration. It is also possible to use ITO (indium tin oxide) or silver nanowires in place of gold if transmissivity, instead of reflectivity, is needed. The ground film 212 may also neutralize stray charges, and may serve as a mirror, allowing observation of droplets when illuminated using an infra-red LED (infra-red does not interfere with fluorescence measurements). In some examples, infra-red light may be used because fluorescence imaging may be done using visible wavelengths. In some examples, imaging may be implemented using any suitable wavelength that does not interfere with other measurements.

In some examples, the electrode 220 and the ground film 212 and/or the electrode 220 and a corresponding electrode 220 may be configured to center or position the droplets and/or its contents in a channel, which may be important in some imaging applications. For example, two liquid electrodes 220 on opposite sides of the channel may be used to produce an electric field that will center a drop. In some examples, such a geometric arrangement of electrodes may be used to pull a drop and hold it at a side wall when the electrode is active, used to split a large drop or combine nearby drops (electric fields can destabilize emulsions temporarily—allowing drops to merge if they collide), slow down droplet flow, push air bubbles away (e.g., air bubbles may have a lower dielectric constant than oil and thereby experiences opposite forces to water droplets), used to pull a droplet out of a continuous stream (as a way to inject/create a droplet), and/or used to merge a droplet into a continuous stream.

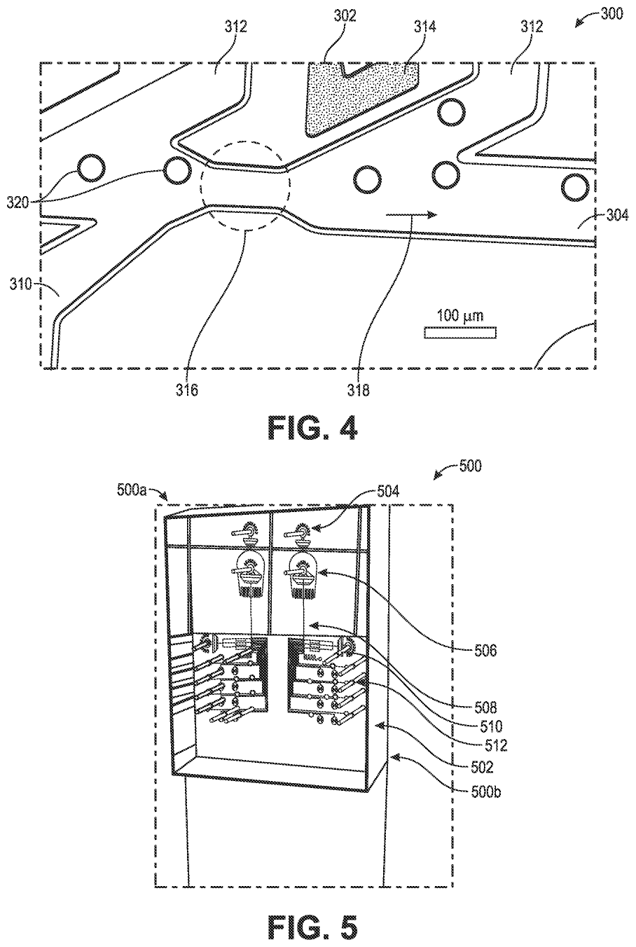

FIG. 3 illustrates a top view of a droplet sorting device 300, according to at least one example. The droplet sorting device 300 is an example of the droplet sorting devices 200 and 108. The droplet sorting device 300 includes nine sorting junctions 302. A first sorting junction 302a is generally depicted in the box. FIG. 4 illustrates a detailed view of a sorting junction 302, according to at least one example. The portion of the droplet sorting device 300 visible in FIG. 3 may correspond to a sorting region because this portion includes the sorting junctions 302.

The droplet sorting device 300 includes a primary channel 304 that extends between a primary inlet 306 and a primary outlet 308. In some examples, the inlet 306 may be disposed at an edge of the droplet sorting device 300 and/or before a detecting region of the droplet sorting device 300 so as to receive droplets and a carrier fluid (e.g., from the droplet generation system 110). The carrier fluid and suspended droplets may flow into the primary channel 304 via the primary inlet 306 in the direction of the primary outlet 308.

The droplet sorting device 300 also includes a plurality of side channels 310 that intersect the primary channel 304 at the sorting junctions 302. For example, the side channel 310a intersects the primary channel 304 at the sorting junction 302a. The plurality of side channels 310 may include individual sources, or may share a source (e.g., the side fluid supply 114). As illustrated, the side channels 310 may include straight sections and serpentine sections. Inclusion of such serpentine sections may increase fluidic resistance of the device 300, which may be useful for controlling the flow of side liquid into the primary channel 304.

The droplet sorting device 300 also includes a plurality of sorting channels 312 that intersect the primary channel 304 at the sorting junctions 302. For example, the sorting channel 312a intersects the primary channel 304 at the sorting junction 302a. In some examples, each sorting channel 312a may include a sorting outlet connected to a sort output 122 (e.g., a reservoir, container, or the like for capturing sorted droplets).

The droplet sorting device 300 also includes a plurality of active electrodes 314 disposed adjacent to the sorting junctions 302. For example, the active electrode 314a includes a distal U-shaped section that is disposed adjacent to the sorting junction 302a. In some examples, the U-shaped section may be a sideways-oriented U that includes a flattened bottom and inwardly facing walls, with the flattened bottom being aligned with a wall of the primary channel 304 that leads into the sorting channel 312. The generally U-shaped section may be connected to one or more linear sections that extend and are electrically connectable to a power source such as the electrode power system 118.

As illustrated in FIG. 4, the primary channel 304 of the droplet sorting device 300 may include a narrowing region 316. As shown in FIG. 4, liquid flow in the primary channel 304 is in the direction of arrow 318. The narrowing region 316, which may be defined prior to the sorting junction 302a, may be useful for increasing separation between droplets 320. In some examples, the width of the primary channel 304 may be about 80 to 100 microns and the width of the narrowing region 316 may be about 30 to 60 microns.

FIG. 5 illustrates a perspective view of a droplet sorting system 500, according to at least one example. The droplet sorting system 500 may be capable of sorting at four sorting junctions, though other examples may provide more or fewer sorting junctions. The droplet sorting system 500 may be configured for use in an upright position, as shown, such as that gravity causes flow of the liquid within the sorting system 500. The droplet sorting system 500 may be configured to include a first sorting system 500a and a second sorting system 500b. These sorting systems 500a and 500b may be identical to each other, so for purposes of clarity, the sorting system 500b is described and labeled. Each droplet sorting system 500 includes a droplet sorting device 502, which is an example of the droplet sorting devices 200 and 300. Droplets are formed outside of the droplet sorting device 502 at a carrier fluid supply 504 (e.g., the carrier fluid supply 112) and sample supply 506 (e.g., the sample supply 111). After droplet formation, features of the droplets are detected in a droplet detection region 508. For purposes of illustration, the feature detection system is not shown in FIG. 5. Next, the droplets are directed into the droplet sorting device 502 via a main channel and flow through the droplet sorting device 502 as described herein. An electrode power system 510 (e.g., the electrode power system 118) is provided in the droplet sorting system 500 to control power delivered to electrodes in the droplet sorting device 502. The droplets are directed into sorting channels and towards one of four sorting outputs 512 based on the operation of the electrodes.

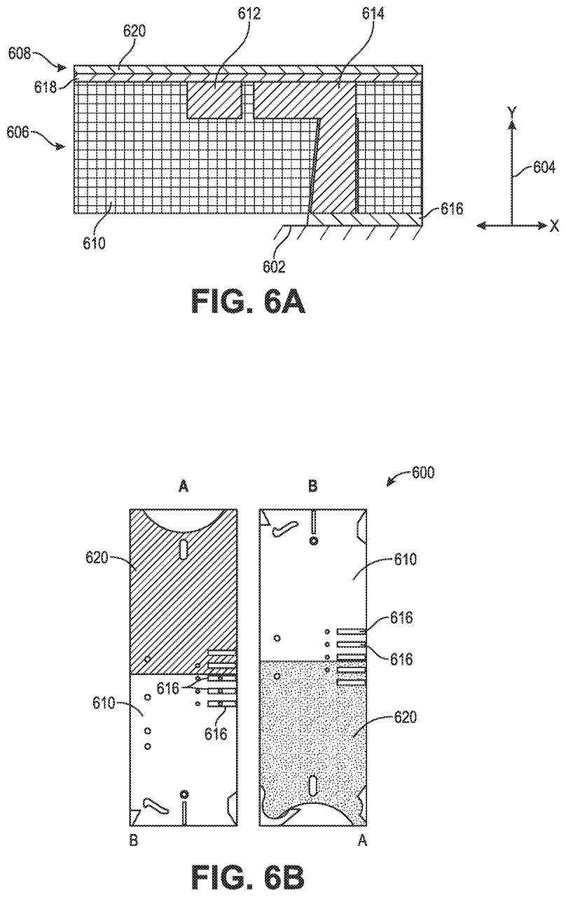

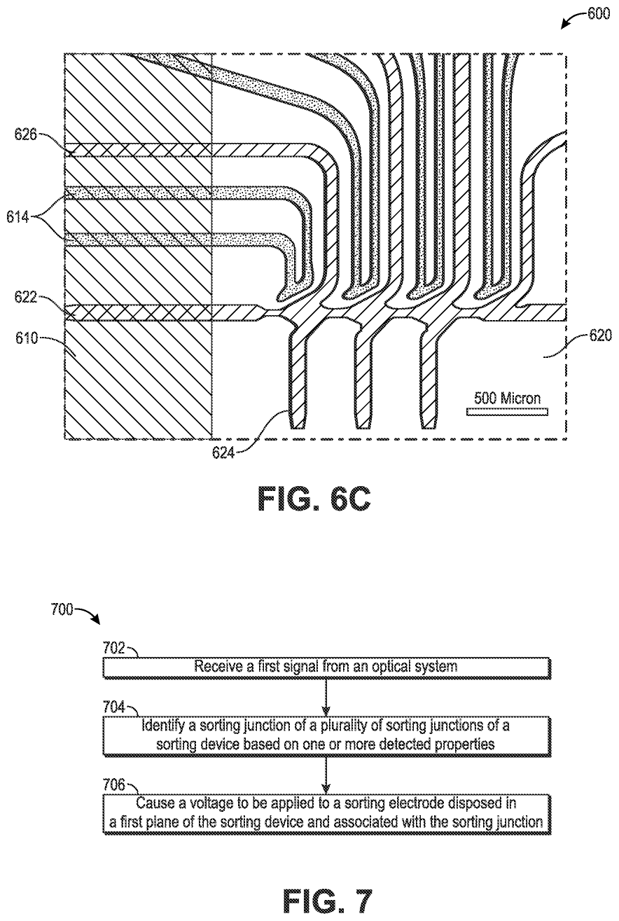

FIGS. 6A, 6B, and 6C respectively illustrate a cross-sectional view, top and bottom views, and a detailed view of a droplet sorting device 600, according to at least one example. The droplet sorting device 600 is an example of the other droplet sorting devices described herein. The droplet sorting device 600 may particularly illustrate the different layers that make up the droplet sorting device 600. Portions of the droplet sorting device 200 may be formed from injection molded cyclic-olefin copolymer (COC) or other suitable material. In some examples, injection molded COC may be suitable for large scale manufacturing. In some examples, as described elsewhere herein, portions of the droplet sorting device 600 may be formed using other techniques. FIG. 6B illustrates a first side and a first orientation (A-B) on the left and a second side in a second orientation (B-A) on the right. In the two orientations, the droplet sorting device has been flipped over end to end.

In FIG. 6A, the droplet sorting device 600 is illustrated as resting on a surface 602 and oriented in a manner extending in a positive Y direction, as shown by axes 604. The droplet sorting device 600 may include a lower portion 606 and an upper portion 608. The lower portion 606 may be formed separate from the upper portion 608, which may then be joined together with the upper portion 608 as part of a later processing step. For example, the lower portion 606 may be injection molded, then joined with the upper portion using any suitable approach.

The lower portion 606 includes a bulk substrate 610 that includes formed therein a fluidic channel 612 and an electrode 614 defined in an electrode channel. The bulk substrate 610 may be injection molded to define the fluidic channel 612 and the electrode 614. As shown in FIG. 6B, the bulk substrate 610 may define the majority of the droplet sorting device 600, which may take the form of rectangular chips (e.g., 25 mm×75 mm). The fluidic channel 612 may have properties similar to the fluidic channel 218. The electrode 614 may include a via or other portion to connect a top portion adjacent the upper portion 608 and a lower portion on the opposite end of the bulk substrate 610. The lower portion of the electrode 614 may be in electrical contact with a conductive trace 616. The conductive trace 616 may be specific to the electrode 614 and electrically isolated from other electrodes 614. The conductive trace 616 may be formed from a conductive material such as gold and be used to connect the electrode 614 to a power supply system. For example, as illustrated in FIG. 6B, the conductive traces 616 extend to outward edges of the bulk substrate 610. Interior walls of the channel in which is found the electrode 614 may be coated with a conductive material such as gold.

The upper portion 608 includes a two-layer component that includes an insulator film 618 and a ground film 620. The insulator film 618 may be configured similar to the insulator film 214, but also functions as a top cover over the bulk substrate 610 and encloses the fluidic channel 612 and the electrode 614. The thickness of the insulator film 618 may be between 20-60 microns. The ground film 620 may be configured similar to the ground film 212. One side of the insulator film 618 may be in physical contact with the top portion of the electrode 614. The ground film 620 may cover one end of the droplet sorting device 600, as shown in FIG. 6C. This may be desirable to enable optical viewing of the droplets in a transparent area of the droplet sorting device 600. In some examples, when a transparent conductor such as indium tin oxide is used for the ground film 620, the entire surface may be coated with the film. As shown in FIG. 6C, in some examples, the ground film 620 may cover only the portion of the droplet sorting device 600 that includes the sorting junctions. In some examples, the ground film 620 may be etched or otherwise cut to follow the contours of the fluidic channels 612 and the electrodes 614.

As shown in FIG. 6C, the droplet sorting device 600 may include a primary channel 622, side channels 624, sorting channels 626 (e.g., the fluidic channels 612), and the electrodes 614. The orientation and design of the sorting junctions in the droplet sorting device 600 may be similar to what was described in FIGS. 3 and 4.

FIG. 7 illustrates an example flow diagram showing process 700, according to at least a few examples. This process, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer readable storage medium, for example, in the form of a computer program including a plurality of instructions executable by one or more processors.

FIG. 7 illustrates an example flow chart depicting a process 700 for sorting droplets according to at least one example. The process 700 is performed by a computer system 800 (FIG. 8).

The process 700 begins at block 702 by the computer system 800 receiving a first signal from an optical system of a droplet sorting system. The first signal may represent one or more detected properties of a droplet present in a liquid. For example, the detected properties may be of an object present in the droplet. For example, the object may be a single cell or molecule, cell, or other microscopic object. The properties may include color, fluorescence, size, and any other suitable property. The signal may be collected using the optical system, which is an example of the optical detection system described herein. In some examples, the properties may be detected in a detection region of a droplet sorting device. For example, the detection region may include a fluidic channel in which the droplet is carried in the fluid. In some examples, the optical system may be configured to detect properties of the object as the droplet (and other droplets) flow through the fluidic channel in the detection region.

At block 704, the process 700 includes the computer system 800 identifying a sorting junction of a plurality of sorting junctions of a sorting device based on the one or more detected properties. The sorting junction may include an intersection between a primary channel and a sorting channel. Each of the plurality of sorting junctions may be preassigned to a certain property. For example, fluorescence of a first type may be assigned to the sorting junction, while fluorescence of a second type is assigned to a second sorting junction. Identifying the sorting junction may include selecting the sorting junction by matching the detected property to the preassigned sorting junction. The number of sorting junctions may depend on the number of properties.

Each sorting junction may also include an active electrode disposed in the same plane as the primary channel and configured to exert an electrical force on droplets in the main channel to draw them into the sorting channel.

At block 706, the process 700 includes the computer system 800, prior to the droplet arriving at the identified sorting junction, causing a voltage to be applied to a sorting electrode disposed in a first plane of the sorting device and associated with the identified sorting junction. The voltage may cause electric charges to flow from the sorting electrode to a ground film disposed in a second plane of the sorting device that is distinct from the first plane. The electric charges may create an electrical field at the sorting junction that directs the droplet from the primary channel to the sorting channel. In some examples, the electric charges may create an electrical field at the sorting junction configured to direct a sorting object into the sorting channel from the primary channel. In some examples, the electric charges may create an electrical field at the sorting junction configured to position a sorting object at a specific location in the primary channel. For example, the electrical field may hold the sorting object within the primary channel for further viewing/analysis. In some examples, the electric charges may create an electrical field at the sorting junction configured to retain a sorting object in physical contact with an interior surface of at least one of the primary channel or the sorting channel. For example, the sorting object may be moved laterally in the channels until it contacts a wall of one of the channels. In some examples, the electric charges may create an electrical field at the sorting junction configured to split a sorting object into two or more smaller sorting objects. For example, a sorting object (e.g., a droplet) may include two objects to be sorted, and may be split accordingly. In some examples, the electric charges may create an electrical field at the sorting junction configured to combine a sorting object with one or more other sorting objects. In some examples, the electric charges may create an electrical field at the sorting junction configured to slow down movement of a sorting object. In some examples, the electric charges create an electrical field at the sorting junction configured to move air bubbles within the primary channel. In some examples, the electric charges create an electrical field at the sorting junction configured to perform at least one of remove a sorting object from a continuous liquid stream and merge the sorting object into the continuous liquid stream.

In some examples, only the identified sorting electrode is activated to sort at the specific sorting junction, while other electrodes are not powered and/or disabled. In some examples, multiple sorting electrodes may be activated at or around the same time to enable simultaneous sortation of droplets in the droplet sorting device. For example, a first droplet may be sorted at one end of a primary channel, while a second droplet is sorted at an opposite end of the primary channel. The computer system may generate the signals that are used by a power system to activate the sorting electrode(s). In some examples, the voltage may cause the droplet to move by dielectrophoresis.

The action at block 706 may be sufficient to divert a droplet from the primary channel to a sorting channel and ultimately into one of the sort outputs. In some examples, the block 706 may include the electrode power system 118 applying a high electrical voltage AC pulse (e.g., ±500-800 V, 10-15 kHz, 1 ms long) to the specific electrode, just as a droplet enters the sorting junction. This application of the electrical voltage at the specific electrode causes electric charges to flow via the insulating layer between the specific electrode and the ground film.

FIG. 8 illustrates a computer system 800 corresponding to a droplet sorting system, according to at least one example. The computer system 800 includes an optical detection system 802 (e.g., silicon avalanche photodiode(s) (SiAPD) 804, photomultiplier tube(s) (PMT) 806, and an analog input PCBA 808), a microprocessor system 810 (e.g., an analog to digital converter 812, a comparator 814, a general purpose input output 816, and a universal asynchronous receiver transmitter 818), an electrode power system 820 (e.g., a high voltage power supply unit 822 and an analog output PCBA 824), a sorting device 826, host computer 828, and a gain control PCBA 830. In some examples, elements of the microprocessor system 810, the analog input PCBA 808 and elements of the electrode power system 820 may be included in the host computer 828, which together may be referred to herein as a computer system. In some examples, the control architecture 800 may be referred to herein as a computer system as computer elements are included in the architecture 800. The computer system may be configured to control aspects of the architecture and/or generate one or more outputs based on the sorting. The control inputs may include changing parameters relating to sorting, timing, changing gates, and the like. The outputs may include graphical user interfaces for presenting information relating to the sorting.

In the following, further examples are described to facilitate the understanding of the present disclosure.
Example 1. In this example, there is provided a sorting device, including:
   a primary channel extending between a primary inlet and a primary outlet;
   a sorting channel extending between a sorting inlet and a sorting outlet, wherein the sorting inlet intersects the primary channel between the primary inlet and the primary outlet at a sorting junction;
   a sorting electrode including a distal portion located adjacent the sorting junction, wherein the primary channel, the sorting channel, and the sorting electrode are disposed in a first plane;
   a ground film disposed in a second plane that is distinct from the first plane; and
   an insulating layer disposed in a third plane that is located between the first plane and the second plane.
Example 2. In this example, there is provided a device of any of the preceding or subsequent examples, wherein, in operation, application of an electrical voltage at the sorting electrode causes electric charges to flow via the insulating layer between the sorting electrode and the ground film.
Example 3. In this example, there is provided a device of any of the preceding or subsequent examples, wherein the electric charges create an electrical field at the sorting junction configured to direct a sorting object into the sorting channel from the primary channel.
Example 4. In this example, there is provided a device of any of the preceding or subsequent examples, wherein the electric charges create an electrical field at the sorting junction configured to position a sorting object at a specific location in the primary channel.
Example 5. In this example, there is provided a device of any of the preceding or subsequent examples, wherein the electric charges create an electrical field at the sorting junction configured to retain a sorting object in physical contact with an interior surface of at least one of the primary channel or the sorting channel.
Example 6. In this example, there is provided a device of any of the preceding or subsequent examples, wherein the electric charges create an electrical field at the sorting junction configured to split a sorting object into two or more smaller sorting objects.
Example 7. In this example, there is provided a device of any of the preceding or subsequent examples, wherein the electric charges create an electrical field at the sorting junction configured to combine a sorting object with one or more other sorting objects.
Example 8. In this example, there is provided a device of any of the preceding or subsequent examples, wherein the electric charges create an electrical field at the sorting junction configured to slow down movement of a sorting object.
Example 9. In this example, there is provided a device of any of the preceding or subsequent examples, wherein the electric charges create an electrical field at the sorting junction configured to move air bubbles within the primary channel.
Example 10. In this example, there is provided a device of any of the preceding or subsequent examples, wherein the electric charges create an electrical field at the sorting junction configured to perform at least one of remove a sorting object from a continuous liquid stream and merge the sorting object into the continuous liquid stream.
Example 11. In this example, there is provided a device of any of the preceding or subsequent examples, wherein the primary channel is configured to receive a first liquid flow including a plurality of sort objects at the primary inlet.
Example 12. In this example, there is provided a device of any of the preceding or subsequent examples, wherein the sorting junction is configured to divert a first object from among the plurality of sort objects into the sorting channel using an electrical field extending between the sorting electrode and the ground film.
Example 13. In this example, there is provided a device of any of the preceding or subsequent examples, further including a side channel extending between a side inlet and a side outlet, wherein the side outlet intersects the primary channel adjacent the sorting junction.
Example 14. In this example, there is provided a device of any of the preceding or subsequent examples, wherein the side channel is configured to deliver a second liquid flow from the side inlet to the primary channel at the side outlet.
Example 15. In this example, there is provided a device of any of the preceding or subsequent examples, wherein at least a first portion of the first liquid flow exits the sorting device via the primary outlet and a second portion of the first liquid flow exits the sorting device via the sorting outlet.
Example 16. In this example, there is provided a device of any of the preceding or subsequent examples, wherein a first height of the sorting channel corresponds to a second height of the sorting electrode.
Example 17. In this example, there is provided a device of any of the preceding or subsequent examples, wherein the first height is substantially similar to the second height.
Example 18. In this example, there is provided a device of any of the preceding or subsequent examples, wherein each of the first height and the second height is between about 25 microns and about 50 microns.
Example 19. In this example, there is provided a device of any of the preceding or subsequent examples, wherein a third height of the ground film is less than both the first height and the second height.
Example 20. In this example, there is provided a device of any of the preceding or subsequent examples, wherein a fourth height of the insulating layer is less than both the first height and the second height, wherein the fourth height is between about 15 microns and about 50 microns.
Example 21. In this example, there is provided a device of any of the preceding or subsequent examples, wherein the sorting electrode includes a rectangular cross section and the ground film includes a conductive film.
Example 22. In this example, there is provided a device of any of the preceding or subsequent examples, wherein:
   the sorting channel is a first sorting channel, the sorting inlet is a first sorting outlet, the sorting outlet is a first sorting outlet, the sorting junction is a first sorting junction, the sorting electrode is a first sorting electrode, and the distal portion is a first distal portion; and
   the sorting device further includes:
   a second sorting channel extending between a second sorting inlet and a second sorting outlet, wherein the second sorting inlet intersects the primary channel between the primary inlet and the primary outlet at a second sorting junction; and
   a second sorting electrode including a second distal portion located adjacent the second sorting junction, wherein the primary channel, the first sorting channel, the second sorting channel, the first sorting electrode, and the second sorting electrode are disposed in the first plane.
Example 23. In this example, there is provided a device of any of the preceding or subsequent examples, wherein, in operation, application of a first electrical voltage at the first sorting electrode causes first electric charges to flow via the insulating layer between the first sorting electrode and the ground film, and wherein, in operation, application of a second electrical voltage at the second sorting electrode causes second electric charges to flow via the insulating layer between the second sorting electrode and the ground film.
Example 24. In this example, there is provided a device of any of the preceding or subsequent examples, wherein the ground film is common with respect to the sorting electrode and other sorting electrodes.
Example 25. In this example, there is provided a device of any of the preceding or subsequent examples, further including a substrate disposed in a fourth plane, the substrate configured to support at least the insulating layer and the ground film, wherein the second plane is located between the third plane and the fourth plane.
Example 26. In this example, there is provided a device of any of the preceding or subsequent examples, wherein the primary channel, the sorting channel, and the sorting electrode are formed in a first component, and the ground film, the insulating layer, and the substrate are formed as a second component that is connected to the first component.
Example 27. In this example, there is provided a device of any of the preceding or subsequent examples, wherein the ground film is formed from a first conductive material and the sorting electrode is formed from a second conductive material that is distinct from the first conductive material.
Example 28. In this example, there is provided a device of any of the preceding or subsequent examples, wherein the first conductive material is a solid and the second conductive material is a liquid.
Example 29. In this example, there is provided a system, including
   a sorting device according to any one of examples 1-28;
   a liquid flow control system configured to introduce a fluid at the primary inlet of the primary channel of the sorting device;
   a droplet system configured to generate droplets to introduce into the fluid;
   an optical system configured to view the droplets in the liquid and generate signals based on detected properties of the droplets; and
   a voltage generation system configured to deliver a voltage to the sorting electrode based on the signals from the optical system.
Example 30. In this example, there is provided a sorting device, including:
   a first substrate;
   a second substrate defining a first plurality of electrode channels and a second plurality of fluidic channels;
   a conductive material layer disposed between the first substrate and the second substrate, wherein the first plurality of electrode channels overlay a portion of the conductive material layer and are configured to form a plurality of independent electrical connections between the first plurality of electrode channels and the conductive material layer; and
   an insulating layer disposed between the first substrate and the conductive material layer.
Example 31. In this example, there is provided a sorting device, including:
   a primary channel extending between a primary inlet and a primary outlet;
   a plurality of sorting junctions defined adjacent to the primary channel between the primary inlet and the primary outlet, wherein each sorting junction of the plurality of sorting junctions includes:
   a sorting channel extending between a sorting inlet that intersects the primary channel at a respective sorting junction and a sorting outlet; and
   a sorting electrode with a distal portion located adjacent to the respective sorting junction; and
   a common electrode that is shared with at least two sorting electrodes of the plurality of sorting junctions, wherein, in operation, the at least two sorting electrodes are independently controllable.
Example 32. In this example, there is provided a computer-implemented method, including:
   receiving a first signal from an optical system, the first signal representing one or more detected properties of a droplet present in a liquid;
   identifying a sorting junction of a plurality of sorting junctions of a sorting device based on the one or more detected properties, the sorting junction including an intersection between a primary channel and a sorting channel; and
   prior to the droplet arriving at the sorting junction, causing a voltage to be applied to a sorting electrode disposed in a first plane of the sorting device and associated with the sorting junction, the voltage causing electric charges to flow from the sorting electrode to a ground film disposed in a second plane of the sorting device that is distinct from the first plane, the electric charges creating an electrical field at the sorting junction that directs the droplet from the primary channel to the sorting channel.
Example 33. In this example, there is provided a method of forming a sorting device, including:
   forming a primary channel in a first plane;
   forming, in the first plane, a set of sorting channels that intersect the primary channel at a plurality of intersections;
   forming a set of sorting electrodes in the first plane; and
   forming a ground film in a second plane that is distinct from the first plane.
Example 34. In this example, there is provided a method of any of the preceding or subsequent examples, further including forming an insulating layer in a third plane between the first plane and the second plane.
Example 35. In this example, there is provided a method of any of the preceding or subsequent examples, wherein forming the set of sorting electrodes includes forming each sorting electrode adjacent to each intersection of the plurality of intersections.
Example 36. In this example, there is provided a method of any of the preceding or subsequent examples, wherein forming the set of sorting electrodes includes:
   forming a set of electrode channels; and
   filling the set of electrode channels with a flowable conductive material.
Example 37. In this example, there is provided a method of any of the preceding or subsequent examples, wherein forming the primary channel, forming the set of sorting channels, and forming the set of electrode channels includes using injection molding.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A sorting device, comprising:
a primary channel extending between a primary inlet and a primary outlet;
a sorting channel extending between a sorting inlet and a sorting outlet, wherein the sorting inlet intersects the primary channel between the primary inlet and the primary outlet at a sorting junction;
a sorting electrode comprising a distal portion located adjacent the sorting junction, wherein the primary channel, the sorting channel, and the sorting electrode are disposed in a first plane;
a ground film disposed in a second plane that is distinct from the first plane; and
an insulating layer disposed in a third plane that is located between the first plane and the second plane.

2. The sorting device of claim 1, wherein, in operation, application of an electrical voltage at the sorting electrode causes electric charges to flow via the insulating layer between the sorting electrode and the ground film.

3. The sorting device of claim 2, wherein the electric charges create an electrical field at the sorting junction configured to direct a sorting object into the sorting channel from the primary channel.

4. The sorting device of claim 2, wherein the electric charges create an electrical field at the sorting junction configured to position a sorting object at a specific location in the primary channel.

5. The sorting device of claim 2, wherein the electric charges create an electrical field at the sorting junction configured to retain a sorting object in physical contact with an interior surface of at least one of the primary channel or the sorting channel.

6. The sorting device of claim 2, wherein the electric charges create an electrical field at the sorting junction configured to split a sorting object into two or more smaller sorting objects.

7. The sorting device of claim 2, wherein the electric charges create an electrical field at the sorting junction configured to combine a sorting object with one or more other sorting objects.

8. The sorting device of claim 2, wherein the electric charges create an electrical field at the sorting junction configured to slow down movement of a sorting object.

9. The sorting device of claim 2, wherein the electric charges create an electrical field at the sorting junction configured to move air bubbles within the primary channel.

10. The sorting device of claim 2, wherein the electric charges create an electrical field at the sorting junction configured to perform at least one of remove a sorting object from a continuous liquid stream and merge the sorting object into the continuous liquid stream.

11. The sorting device of claim 1, wherein the primary channel is configured to receive a first liquid flow comprising a plurality of sort objects at the primary inlet.

12. The sorting device of claim 11, wherein the sorting junction is configured to divert a first object from among the plurality of sort objects into the sorting channel using an electrical field extending between the sorting electrode and the ground film.

13. The sorting device of claim 11, further comprising a side channel extending between a side inlet and a side outlet, wherein the side outlet intersects the primary channel adjacent the sorting junction.

14. (canceled)

15. The sorting device of claim 11, wherein at least a first portion of the first liquid flow exits the sorting device via the primary outlet and a second portion of the first liquid flow exits the sorting device via the sorting outlet.

16. The sorting device of claim 1, wherein a first height of the sorting channel corresponds to a second height of the sorting electrode.

17. The sorting device of claim 16, wherein the first height is substantially similar to the second height.

18. The sorting device of claim 17, wherein each of the first height and the second height is between about 25 microns and about 50 microns.

19. The sorting device of claim 16, wherein a third height of the ground film is less than both the first height and the second height.

20. The sorting device of claim 19, wherein a fourth height of the insulating layer is less than both the first height and the second height, wherein the fourth height is between about 15 microns and about 50 microns.

21. The sorting device of claim 1, wherein the sorting electrode comprises a rectangular cross section and the ground film comprises a conductive film.

22. The sorting device of claim 1, wherein:
the sorting channel is a first sorting channel, the sorting inlet is a first sorting inlet, the sorting outlet is a first sorting outlet, the sorting junction is a first sorting junction, the sorting electrode is a first sorting electrode, and the distal portion is a first distal portion; and
the sorting device further comprises:
a second sorting channel extending between a second sorting inlet and a second sorting outlet, wherein the second sorting inlet intersects the primary channel between the primary inlet and the primary outlet at a second sorting junction; and
a second sorting electrode comprising a second distal portion located adjacent the second sorting junction, wherein the primary channel, the first sorting channel, the second sorting channel, the first sorting electrode, and the second sorting electrode are disposed in the first plane.

23. The sorting device of claim 22, wherein, in operation, application of a first electrical voltage at the first sorting electrode causes first electric charges to flow via the insulating layer between the first sorting electrode and the ground film, and wherein, in operation, application of a second electrical voltage at the second sorting electrode causes second electric charges to flow via the insulating layer between the second sorting electrode and the ground film.

24. The sorting device of claim 1, wherein the ground film is common with respect to the sorting electrode and other sorting electrodes.

25. The sorting device of claim 1, further comprising a substrate disposed in a fourth plane, the substrate configured to support at least the insulating layer and the ground film, wherein the second plane is located between the third plane and the fourth plane.

26. The sorting device of claim 25, wherein the primary channel, the sorting channel, and the sorting electrode are formed in a first component, and the ground film, the insulating layer, and the substrate are formed as a second component that is connected to the first component.

27. The sorting device of claim 1, wherein the ground film is formed from a first conductive material and the sorting electrode is formed from a second conductive material that is distinct from the first conductive material.

28. The sorting device of claim 27, wherein the first conductive material is a solid and the second conductive material is a liquid.

29. A sorting system, comprising:
a sorting device, comprising:
a primary channel extending between a primary inlet and a primary outlet;
a sorting channel extending between a sorting inlet and a sorting outlet, wherein the sorting inlet intersects the primary channel between the primary inlet and the primary outlet at a sorting junction;
a sorting electrode comprising a distal portion located adjacent the sorting junction, wherein the primary channel, the sorting channel, and the sorting electrode are disposed in a first plane;
a ground film disposed in a second plane that is distinct from the first plane;
an insulating layer disposed in a third plane that is located between the first plane and the second plane;
a liquid flow control system configured to introduce a fluid at the primary inlet of the primary channel of the sorting device;
a droplet system configured to generate droplets to introduce into the fluid;
an optical system configured to view the droplets in the fluid and generate signals based on detected properties of the droplets; and
a voltage generation system configured to deliver a voltage to the sorting electrode based on the signals from the optical system.

30. A sorting device, comprising:
a first substrate;
a second substrate defining a first plurality of electrode channels and a second plurality of fluidic channels;
a conductive material layer disposed between the first substrate and the second substrate, wherein the first plurality of electrode channels overlay a portion of the conductive material layer and are configured to form a plurality of independent electrical connections between the first plurality of electrode channels and the conductive material layer; and
an insulating layer disposed between the first substrate and the conductive material layer.

31. (canceled)

32. A computer-implemented method, comprising:
receiving a first signal from an optical system, the first signal representing one or more detected properties of a droplet present in a liquid;
identifying a sorting junction of a plurality of sorting junctions of a sorting device based on the one or more detected properties, the sorting junction comprising an intersection between a primary channel and a sorting channel; and
prior to the droplet arriving at the sorting junction, causing a voltage to be applied to a sorting electrode disposed in a first plane of the sorting device and associated with the sorting junction, the voltage causing electric charges to flow from the sorting electrode to a ground film disposed in a second plane of the sorting device that is distinct from the first plane, the electric charges creating an electrical field at the sorting junction that directs the droplet from the primary channel to the sorting channel.

33. A method of forming a sorting device, comprising:
forming a primary channel in a first plane;
forming, in the first plane, a set of sorting channels that intersect the primary channel at a plurality of intersections;
forming a set of sorting electrodes in the first plane; and
forming a ground film in a second plane that is distinct from the first plane.

34. The method of claim 33, further comprising forming an insulating layer in a third plane between the first plane and the second plane.

35. The method of claim 33, wherein forming the set of sorting electrodes comprises forming each sorting electrode adjacent to each intersection of the plurality of intersections.

36. The method of claim 33, wherein forming the set of sorting electrodes comprises:
forming a set of electrode channels; and
filling the set of electrode channels with a flowable conductive material.

37. The method of claim 36, wherein forming the primary channel, forming the set of sorting channels, and forming the set of electrode channels comprises using injection molding.
